(19) United States
(12) Patent Application Publication
(10) Pub. No.: US 2026/0008376 A1
(43) Pub. Date: Jan. 8, 2026

(54) DISPLAY SCREEN NOTIFICATION OF BATTERY CHARGER CONNECTION WITH VEHICLE BATTERY SYSTEM

(71) Applicant: Crown Equipment Corporation, New Bremen, OH (US)

(72) Inventors: Chad Sollmann, Sidney, OH (US); John Harman, Versailles, OH (US); Jordon Coffman, Celina, OH (US); Shanica Hardesty, Lima, OH (US)

(21) Appl. No.: 19/112,334

(22) PCT Filed: Oct. 20, 2023
(86) PCT No.: PCT/US2023/035568

§ 371 Date: Mar. 17, 2025

Related U.S. Application Data
(60) Provisional application No. 63/381,203, filed on Oct. 27, 2022.

(51) Int. Cl. B60L 53/65; H02J 7/00

(52) U.S. Cl. CPC B60L 53/65; H02J 7/00036; H02J 7/0045; H02J 7/0047; B60L 2250/16

(57) ABSTRACT

A batten-charger for a battery system is provided. The battery system may be adapted to provide power to a vehicle. The battery charger may comprise; a housing; a charger connector adapted to be connected with a mating connector of the battery system; memory storing executable instructions; and a processor in communication with the memory. The processor when executing the executable instructions may: determine that identification information from the battery system is received by the processor via the charger connector. After the identification information from the battery system is received, the processor may generate first information indicating that the battery charger is connecting with the battery system.

### BACKGROUND ART

It is known to connect a battery charger to a battery system comprising a lithium battery, where the battery system is adapted to provide power to a vehicle, such as a material handling vehicle. It is also known to provide an operator with an indication, such as via indicator lights, that a “charging” operation has been initiated.

### DISCLOSURE OF INVENTION

In accordance with a first aspect, a battery charger for a battery system is provided. The battery system may be adapted to provide power to a vehicle. The battery charger may comprise: a housing; a charger connector adapted to be connected with a mating connector of the battery system; memory storing executable instructions; and a processor in communication with the memory. The processor when executing the executable instructions may: determine that identification information from the battery system is received by the processor via the charger connector. The identification information may be received by the charger connector via a vehicle network. After the identification information from the battery system is received, the processor may generate first information indicating that the battery charger is connecting with the battery system.

The battery charger may further comprise a screen display, wherein the first information may be displayed on the screen display indicating that the battery charger is connecting with the battery system. The first information displayed on the screen display may comprise graphic and/or alphanumeric information indicating that the battery charger is connecting with the battery system.

The battery charger may further comprise one or more signal emitting devices. The processor when executing the executable instructions: after the identification information from the battery system is received, may generate further first information by activating the one or more signal emitting devices to generate a first visual signal at the one or more signal emitting devices.

The identification information from the battery system may comprise a node identification.

The processor when executing the executable instructions: may determine that a charger detect signal from the battery system is received by the processor via the charger connector.

The processor when executing the executable instructions: after the charger detect signal is received, may generate second information indicating that the battery charger is connected with the battery system.

The second information may be displayed on the screen display indicating that the battery charger is connected with the battery system. The second information displayed on the screen display may comprise graphic and/or alphanumeric information indicating that the battery charger is connected with the battery system.

The battery charger may further comprise a speaker. The processor when executing the executable instructions: after the charger detect signal is received, may generate further second information by causing the speaker to emit a first sound indicative that the battery charger is connected with the battery system.

The battery charger may further comprise a charging system for recharging the battery system. The second information may be generated prior to the charging system starting a recharging operation for the battery system.

In accordance with a second aspect, a method is provided for providing information regarding connecting a battery charger with a battery system. The battery system may be adapted to provide power to a vehicle. The method may comprise: determining, by a processor of the battery charger, that identification information from the battery system is received. The identification information may be received by the processor via a vehicle network. After the identification information from the battery system is received, the method may further comprise generating, by the processor, first information indicating that the battery charger is connecting with the battery system.

The method may further comprise: causing, by the processor, the first information to be displayed on a screen display indicating that the battery charger is connecting with the battery system. The first information displayed on the screen display may comprise graphic and/or alphanumeric information indicating that the battery charger is connecting with the battery system.

The method may further comprise: after the identification information from the battery system is received, generating, by the processor, further first information by activating one or more signal emitting devices to generate a first visual signal at the one or more signal emitting devices.

The identification information from the battery system may comprise a node identification.

The method may further comprise: determining, by the processor, that a charger detect signal from the battery system is received by the processor via the charger connector.

The method may further comprise: after the charger detect signal is received, generating. by the processor, second information indicating that the battery charger is connected with the battery system.

The method may further comprise: causing, by the processor, the second information to be displayed on a screen display indicating that the battery charger is connected with the battery system. The second information displayed on the screen display may comprise graphic and/or alphanumeric information indicating that the battery charger is connected with the battery system.

The method may further comprise: after the charger detect signal is received, causing, by the processor, a speaker to emit a first sound indicative that the battery charger is connected with the battery system.

The second information may be generated prior to a charging system starting a recharging operation for the battery system.

The first information may be generated prior to a charging system starting a recharging operation for the battery system.

In accordance with a third aspect, a battery charger is provided for a battery system. The battery system may be adapted to provide power to a vehicle. The battery charger may comprise: a housing; a charger connector adapted to be connected with a mating connector of the battery system; memory storing executable instructions: and a processor in communication with the memory. The processor when executing the executable instructions may: determine that a charger detect signal from the battery system is received by the processor via the charger connector; and after the charger detect signal is detected, generate information indicating that the battery charger is connected with the battery system.

The information indicating that the battery charger is connected with the battery system may be generated prior to a charging system starting a recharging operation for the battery system.

The battery charger may further comprise a screen display, wherein the information may be displayed on the screen display indicating that the battery charger is connected with the battery system.

### BRIEF DESCRIPTION OF DRAWINGS

FIG. 1 is a plan view of an industrial vehicle including a battery system;

FIG. 2 is a block diagram of a processing device of the vehicle of FIG. 1;

FIG. 3 is a block diagram of the battery system of the vehicle in FIG. 1 and a battery charger in accordance with the principles of the present disclosure;

FIG. 4 is view of a battery charger connector in accordance with the principles of the present disclosure;

FIG. 5 is a state diagram of a battery controller of the battery system;

FIG. 6 is a flow chart of an exemplary computer-implemented process for operating the battery controller;

FIG. 7 is a state diagram of a battery charger controller of the battery charger;

FIG. 8 is a flow chart of an exemplary computer-implemented process for operating the battery charger controller; and

FIGS. 9A-9C are schematic screen shots of the display screen of the battery charger;

FIGS. 10A and 10B are schematic views of LEDs on a front of a battery charger housing.

### BEST MODE FOR CARRYING OUT THE INVENTION

In the following detailed description of the illustrated embodiments, reference is made to the accompanying drawings that form a part hereof, and in which is shown by way of illustration, and not by way of limitation, specific embodiments in which the invention may be practiced. It is to be understood that other embodiments may be utilized and that changes may be made without departing from the spirit and scope of various embodiments of the present disclosure.

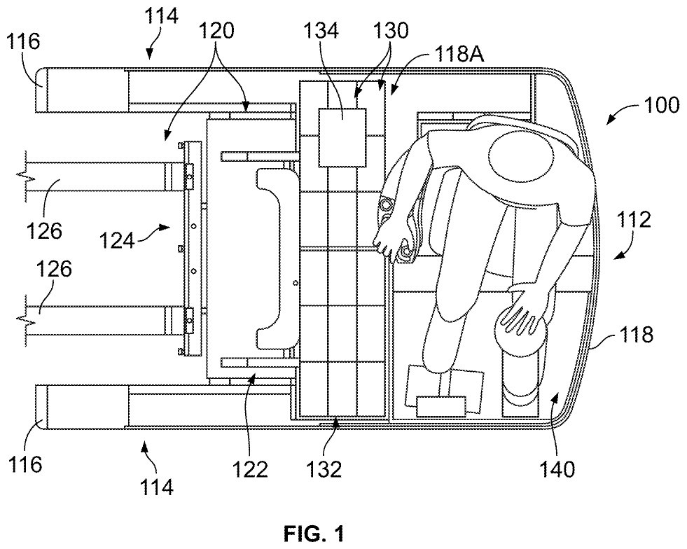

With reference to FIG. 1, an exemplary industrial vehicle 100 (hereinafter “vehicle”) is shown. While the present disclosure is made with reference to the illustrated vehicle 100, which comprises a reach truck, it will be apparent to those of skill in the art that the vehicle 100 may comprise a variety of other industrial vehicles, such as a stock picker, a turret truck, a tow tractor, a rider pallet truck, a walkie stacker truck, a counterbalance forklift truck, etc. or any other vehicle, and the following description of the invention with reference to the figures should not be limited to a reach truck unless otherwise specified.

The vehicle 100 comprises a main body or power unit 112 and one or more wheels, including a pair of outriggers 114 provided with front wheels 116 and a powered and steered further wheel (not shown) located underneath a frame 118 of the power unit 112. The vehicle 100 further comprises a load handling assembly 120, which generally comprises a mast assembly 122 and a carriage assembly 124, including a pair of forks 126. A battery system 130 is provided comprising a battery 132 housed in a battery compartment 118A within the frame 118, which supplies power to the vehicle 100, such as a traction motor (not shown) that is connected to the powered and steered further wheel and to one or more hydraulic motors (not shown). In the illustrated embodiment, the battery 132 comprises a lithium ion battery. The battery may include other battery types, such as a lead acid battery. The hydraulic motor(s) supply pressurized hydraulic fluid to several different systems, such as one or more hydraulic cylinders (not shown) for effecting generally vertical movement of one or more movable mast members of the mast assembly 122 relative to a fixed mast member of the mast assembly 122 and generally vertical movement of the carriage assembly 124 relative to the one of the movable mast members of the mast assembly 122. The traction motor and the further wheel define a drive mechanism for effecting movement of the vehicle 100 across a floor surface. An operator's compartment 140 is located within the power unit 112 for receiving an operator driving or operating the vehicle 100. The operator's compartment 140 comprises a variety of control elements including one or more handles, knobs, levers, switches, buttons, sliders. encoders, and combinations thereof, along with one or more devices that display information to the operator and/or receive operator input.

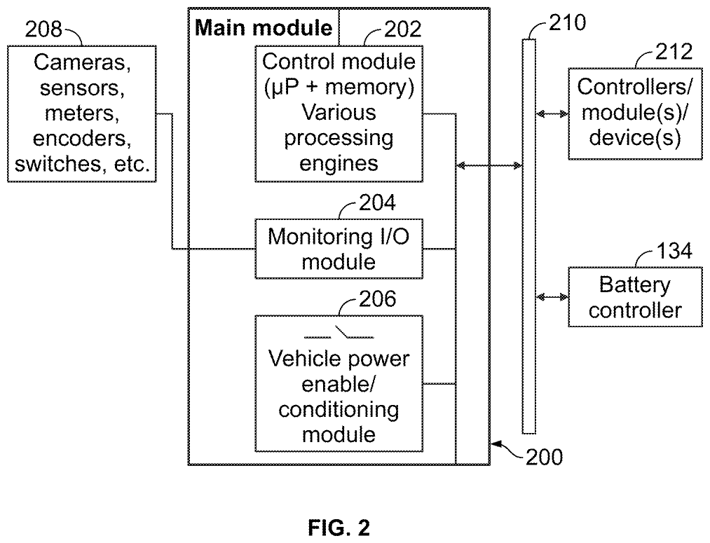

The vehicle 100 further comprises a processing device 200, see FIG. 2. The processing device 200 may comprise a special purpose, particular hardware computer, such as a device that mounts to or is otherwise integrated with the vehicle 100. The computer of the processing device 200 may comprise data processing circuitry (illustrated generally as the control module 202) comprising one or more processors (μP) coupled to a memory for implementing executable instructions, including the relevant processes, or aspects thereof, as set out and described more fully herein. The memory may comprise memory that stores processing instructions, as well as memory for data storage. e.g., to implement one or more databases, data stores, registers, arrays, etc. The processing device 200 may also optionally comprise vehicle power enabling circuitry 206 to selectively enable or disable the vehicle 100, e.g., depending upon a status of a power contactor 138 forming part of the battery system 130, as discussed further below. Hence, the vehicle power enabling circuitry 206 may partially or fully enable the vehicle 100 for operation. Still further, the processing device 200 may comprise a monitoring input/output (I/O) module 204 to communicate with the control module 202 and one or more peripheral devices mounted to or otherwise associated with the vehicle 100, such as one or more cameras, sensors, meters, encoders, switches, etc. (not separately labeled: collectively represented by reference numeral 208). The processing device 200 is coupled to and/or communicates with other vehicle system components via a suitable vehicle network system 210. The vehicle network system 210 may comprise at least one network, bus, or other communications capability or combination thereof that allows electronic components of the vehicle 100 to communicate with each other. As an example. the vehicle network system 210 may comprise a controller area network (CAN) bus. ZigBee, Bluetooth®, Local Interconnect Network (LIN), time-triggered data-bus protocol (TTP), RS422 bus, Ethernet, universal serial bus (USB), other suitable communications technology, or combinations thereof. Utilization of the vehicle network system 210 enables seamless integration of the components of the vehicle 100 with the processing device 200, and in particular, the control module 202. By way of example, the vehicle network system 210 enables communication between the control module 202 and one or more native vehicle components, such as a vehicle control module, controllers (e.g., traction controller, hydraulics controller, etc.), modules, devices, bus-enabled sensors, displays, lights, light bars, sound generating devices, etc. (designated generally by reference numeral 212). A battery controller 134, forming part of the battery system 130, is coupled to the vehicle network system 210 to allow the battery controller 134 to communicate with the control module 202, as will be discussed further below.

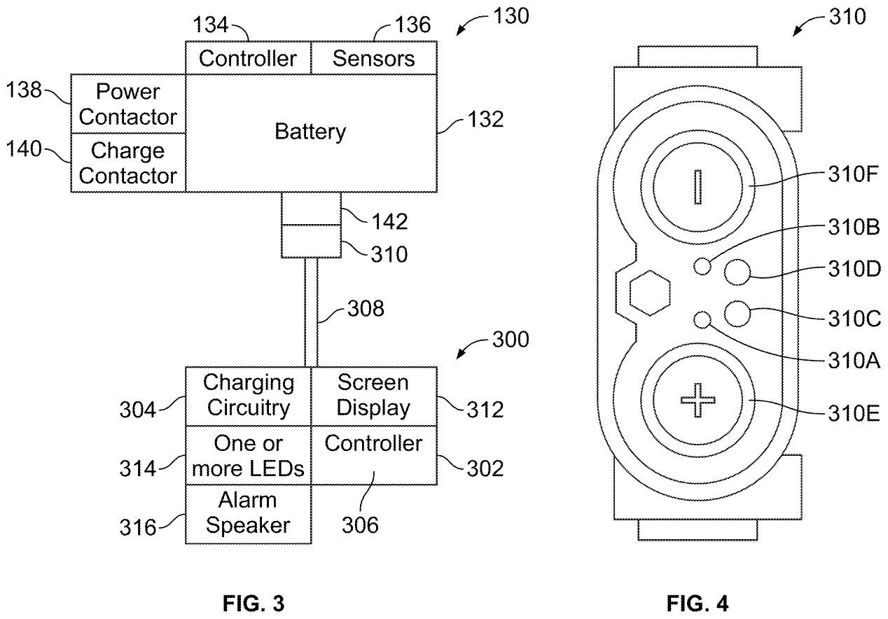

The battery system 130 further comprises one or more sensors 136, for sensing or measuring battery parameters such as current (drawn from the battery or supplied to the battery during use, such as in regenerative braking, or supplied to the battery during a charging operation, etc.), voltage, resistance, temperature (ambient or within the battery), fluid level, impedance, resistance, dynamic/transient loading, battery chemistry or any other measurable parameter of interest in monitoring of a battery, see FIGS. 2 and 3. The battery controller 134 may comprise one or more processors coupled to a memory for implementing executable instructions, such as computational steps performed by one or more computer programs or applications, in accordance with the relevant processes, or aspects thereof, as set out and described more fully herein. The memory may comprise memory that stores processing instructions, as well as memory for data storage.

A battery charger 300 may be provided for charging the battery 132, see FIGS. 3 and 10A. The battery charger 300 may comprise a housing 302, charging circuity or system 304 for generating charging current for charging the battery 132, a battery charger controller 306, a charging cable 308 with a connector 310, a screen display 312 and one or more light-emitting diodes (LEDs) 314 or like light emitting elements. The battery charger controller 306 may comprise one or more processors coupled to a memory for implementing executable instructions, including the relevant processes, or aspects thereof, as set out and described more fully herein. The memory may comprise memory that stores processing instructions, as well as memory for data storage.

The battery system 130 further comprises a battery connector 142, which is adapted to be mated with the battery charger connector 310 during a battery charging operation. A cable (not shown) may be coupled to the battery connector 142. An end view of the battery charger connector 310 is illustrated in FIG. 4. The connector 310 comprises first and second pilot pins 310A, 310B, first and second network pins 310C and 310D, which communicate with the network system (e.g., a CAN bus) via the battery system 130, and first and second power contacts 310E and 310F. The battery connector 142 has mating first and second pilot conductors, first and second network conductors and first and second power conductors.

When an operator wishes to charge the battery 132, the operator couples or mates the battery charger connector 310 with the battery connector 142 by, for example, manually joining the two connectors 310 and 142 together. When the battery system 130 is ON, a voltage is constantly provided on the first pilot conductor of the battery connector 142. When the battery and battery charger connectors 142 and 310 are joined together, the first and second pilot pins 310A and 310B are connected to the first and second pilot conductors on the battery connector 142, such that a voltage or pilot signal passes from the first pilot conductor, through the first and second pilot pins 310A and 310B back to the second pilot conductor. The battery controller 134 detects this voltage or pilot signal on the second conductor and, in response, changes a state of a “charger detect” bit stored in memory from, e.g., 0 to 1, to designate that the battery charger connector 310 has been sensed by the battery controller 134. The battery controller 134 then sends a message containing the “charger detect” bit (also referred to herein as a “charger detect signal”) with a value of 1 to the battery charger controller 306 over the network system, e.g., via a CAN message sent over the CAN bus. It is further contemplated that when the battery controller 134 detects the voltage or pilot signal on the second conductor and changes a state of a “charger detect” bit stored in memory, it may change the bit from 1 to 0 instead of 0 to 1, to designate that the battery charger connector 310 has been sensed by the battery controller 134.

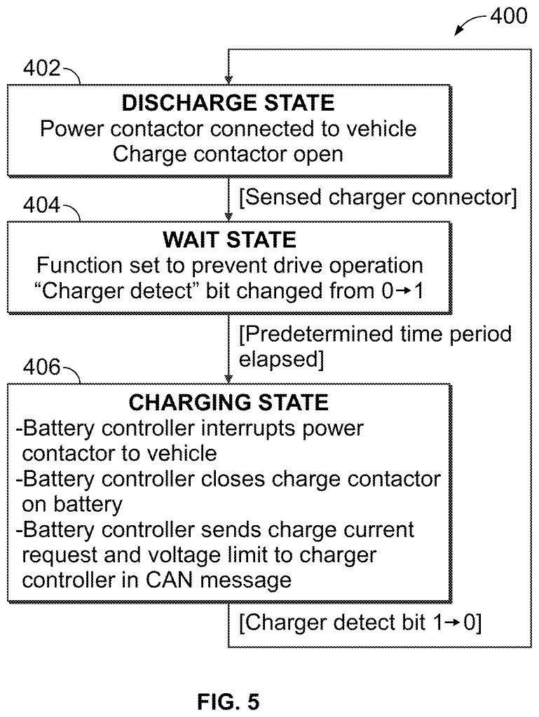

FIG. 5 provides a state diagram 400 representing various states of the battery controller 134 before, during and after a battery charging operation. One of ordinary skill will recognize that the depicted state diagram is merely a model of computational steps performed by one or more computer programs or applications executed by the one or more processors of the battery controller 134. The state diagram of FIG. 5 provides three states, which are: a Discharge State 402; a Wait State 404; and a Charging State 406. During the discharge state 402, the battery 132 is in a discharge mode where the battery 132 is providing power to the vehicle 100, i.e., the battery 132 is discharging. When in the discharge state 402, the power contactor 138 may be in a state where it is connected to the vehicle 100 such that current may be delivered to the vehicle 100. Also when in the discharge state 402, the charge contactor 140 may be in a state where it is disconnected from the battery charger 300, such that charging of the battery 132 cannot occur. The battery controller 134 controls the state of the power and charge contactors 138, 140 via actuation of solenoids or like devices coupled to the power and charge contactors 138, 140.

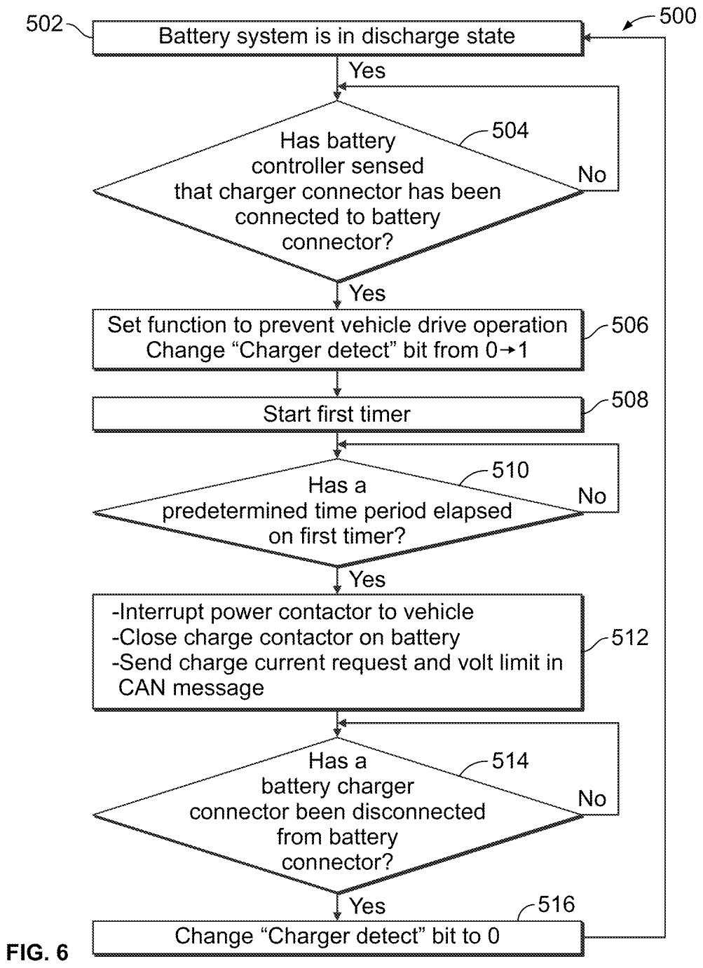

Exit conditions for the battery controller 134 to change states 402, 404 and 406, will be noted during the following discussion of a flowchart 500 illustrated in FIG. 6. The flowchart 500 in FIG. 6 is an example computer implemented process for operation of the battery controller 134 before, during and after a battery charging operation. The process in FIG. 6 can, for example, be implemented with executable code that is executed by the one or more processors of the battery controller 134. A number of operating conditions of the vehicle 100 or the battery system 130 can be sensed using appropriate sensors located on components of the vehicle 100 or the sensors 136 on the battery system 130. These sensed values can be used directly by the processes set out herein or can be used to derive other values which can be used by the processes set out herein.

In step 502, the battery controller 134 determines that the battery system is in the discharge state, which corresponds to state 402 discussed above. When the battery controller 134 receives the pilot signal conducted on the second pilot conductor on the battery connector 142, the battery controller 134 determines that the charger connector 310 has been coupled or connected to the battery connector 142, see step 504, i.e., the battery controller 134 senses the charger connector 310. The battery controller 134 then changes from the discharge state 402 to the wait state 404. Once in the wait state 404, see also step 506, the battery controller 134 generates a “set function to prevent drive operation” message. e.g., a CAN message sent via the CAN bus, to the vehicle processing device 200 instructing the processing device 200 to disable the vehicle 100 from being driven by an operator or otherwise. The battery controller 134 further changes the state of the “charger detect” bit stored in the memory of the battery controller 134 from 0 to 1 to indicate that the charger connector 310 has been sensed by the battery controller 134 via the pilot signal.

After step 506, the battery controller 134 starts a first timer, see step 508. When a predetermined time period as measured by the first timer has elapsed, e.g., 15 seconds or any other desired time period, the battery controller 134 transitions to the charging state 406. The predetermined time period as measured by the first timer defines a safety time period to allow the vehicle 100 to come to a controlled stop prior to power being shut or cut off to the vehicle 100 before charging. Once in the charging state 406, the battery controller 134 causes the power contactor 138 to move to an open state where it is not connected to the vehicle 100 such that current is not delivered to the vehicle 100 from the battery 132 and, further, causes the charge contactor 140 to move to a closed state where it is connected to the battery charger 300, such that charging of the battery 132 may occur. The battery controller 134 also sends one or more messages over the network system 210, e.g., via the CAN bus, requesting that charging current be provided by the charger 300, i.e., via the charging circuitry 304, to the battery 132 and also defines a voltage limit. The voltage limit sent by the battery controller 134 to the battery charger controller 306 comprises a “not to exceed” voltage or voltage limit for the battery charger 300 when charging the battery 132.

Once the battery charger connector 310 has been disconnected from the battery connector 142, see step 514, the battery controller 134 will change the state of the “charger detect” pin, e.g., from 1 to 0, see step 516, and return to the step 502.

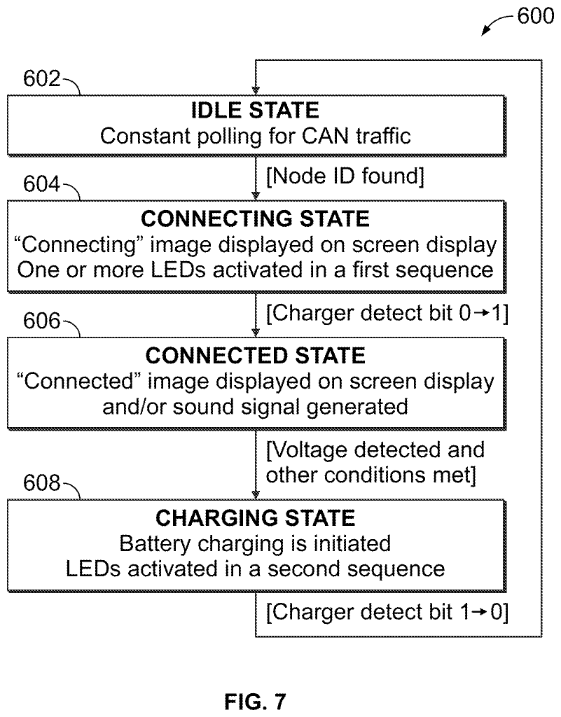

FIG. 7 provides a state diagram 600 representing various states of the battery charger controller 306 before, during and after a battery charging operation. One of ordinary skill will recognize that the depicted state diagram 600 is merely a model of computational steps performed by one or more computer programs or applications executed by the one or more processors of the battery charger controller 306. The state diagram of FIG. 7 provides four states, which are: an Idle State 602; a Connecting State 604; a Connected State 606; and a Charging State 608.

Each electronic component of the vehicle 100 as well as the battery system 130, which is connected to and a participant on the network system 210, may broadcast messages at a Baud-rate (a rate or speed at which data is transmitted on the network) defined for the network system 210, wherein each message may include an identifier, i.e., a node ID, linking or defining the identity of the participant on the system 210 that generated the message, and a message to be communicated. The battery charger controller 306, when the battery charger connector 310 is coupled to the battery connector 142, may be coupled to the network system 210 via the battery system 130. A message broadcast from a first participant can be received by all nodes or participants connected to the network system via, e.g., the CAN bus. Each participant may be programmed to decide, e.g., based upon the identifier or other information encoded in each received message, whether that participant should take action based upon the received message. As such, each network participant may broadcast or otherwise communicate with one or more of the other participants of the network system 110.

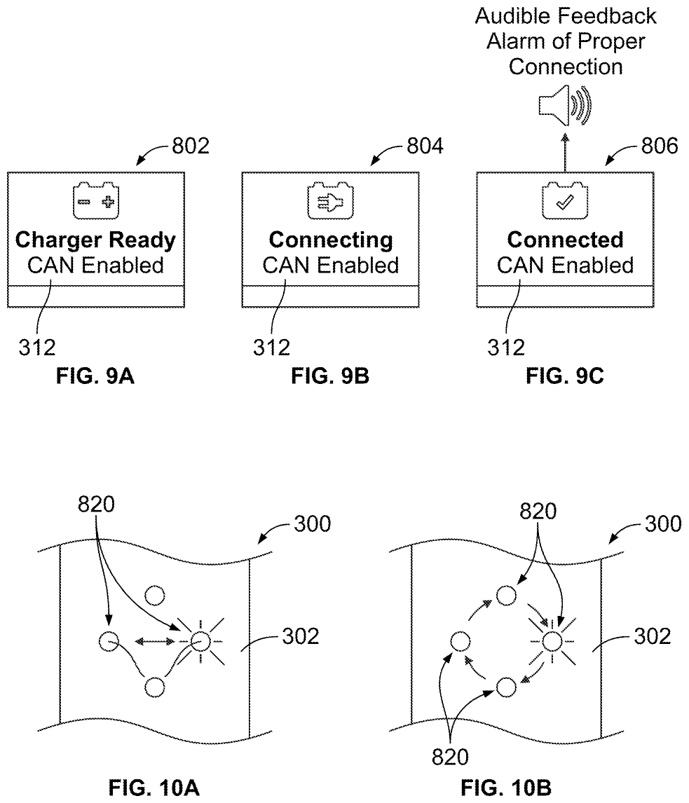

During the idle state 602, the battery charger controller 306 continuously polls for message traffic, e.g., CAN messages, on the vehicle network system 210, e.g., the CAN bus. Once the battery charger connector 310 has been coupled to the battery connector 142, the battery charger controller 306 may see messages broadcast from the vehicle 100 and/or the battery system 130 over the network system 210. When the battery charger controller 306 begins to see messages on the network system 210 and receives and identifies at least one message with a node ID corresponding to the battery controller 142, the battery charger controller 306 knows that the battery charger connector 310 has been coupled to the battery connector 142. At that point, the battery charger controller 306 changes from the idle state 602 to the connecting state 604, see FIG. 7, such that it changes any existing image on the screen display 312, such as a “charger ready” image 802, see FIG. 9A, to a “connecting” image 804, see FIG. 9B. Any other graphic and/or alphanumeric information indicating that the battery charger is connecting with the battery system may be displayed on the screen display 312. The battery charger controller 306 may also activate one or more of the LEDs 820 on a front of the battery charger housing 302 to create a first visual signal. For example, two of the LEDs 820 may be activated in an alternating manner, e.g., while one LED is ON the other LED is OFF, to generate the first visual signal. It is also contemplated that one or more of the LEDs 820 may be activated in any other manner so as to generate the first visual signal.

As noted above, when the battery controller 134 detects the pilot signal, it changes the state of the “charger detect” bit from 0 to 1. The battery controller 134 then sends a message containing the “charger detect” bit=1 over the network system, e.g., via the CAN bus. The battery charger controller 306 is programmed to look for and receive messages from the battery controller 134 on the CAN bus such that when it receives the message with the “charger detect” bit=1, the battery charger controller 306 changes from the “connecting” state 604 to the “connected” state 606, see FIG. 7.

When in the “connected” state 606, the battery charger controller 306 may change the “connecting” image 804 to a “connected” image 806. see FIG. 9C. Any other graphic and/or alphanumeric information indicating that the battery charger is connected with the battery system may be displayed on the screen display 312.

The battery charger controller 306 may also activate an alarm speaker 316 forming part of the battery charger 300 so as to generate an audible-feedback to an operator, such as an “connected” alarm tone generated for a predefined period of time, e.g., one second.

It is contemplated that once the battery charger connector 310 has been coupled to the battery connector 142, the first message with a node ID corresponding to the battery controller that the battery charger controller 306 may see is a message containing the “charger detect” bit=1. In such a case, the battery charger controller 306 may change the screen display 312 from the the “charger ready” image 802 to the “connecting” image 804 and then immediately to the “connected” image 806.

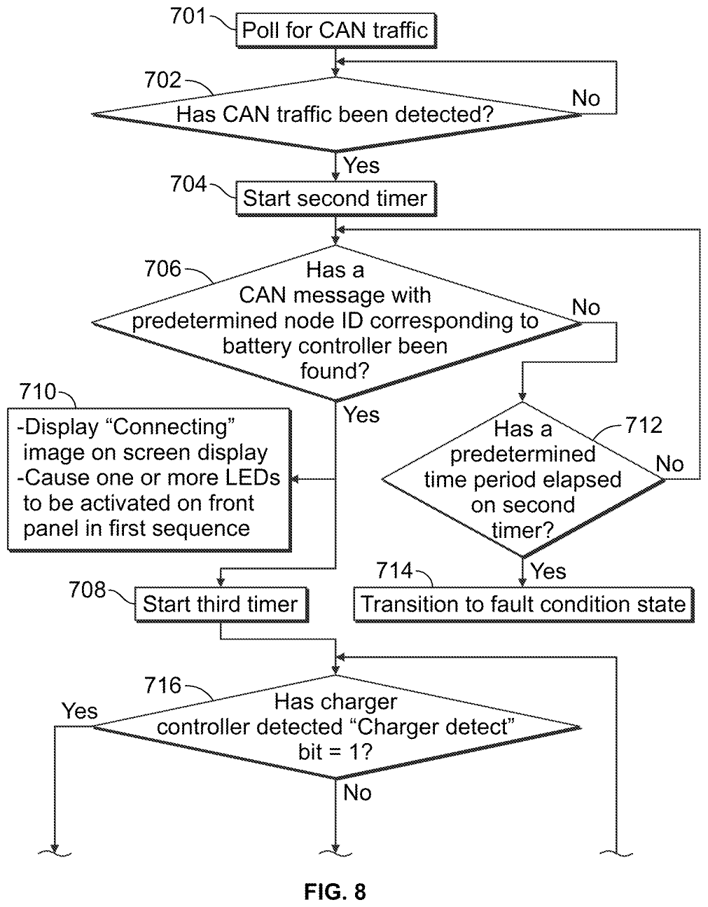

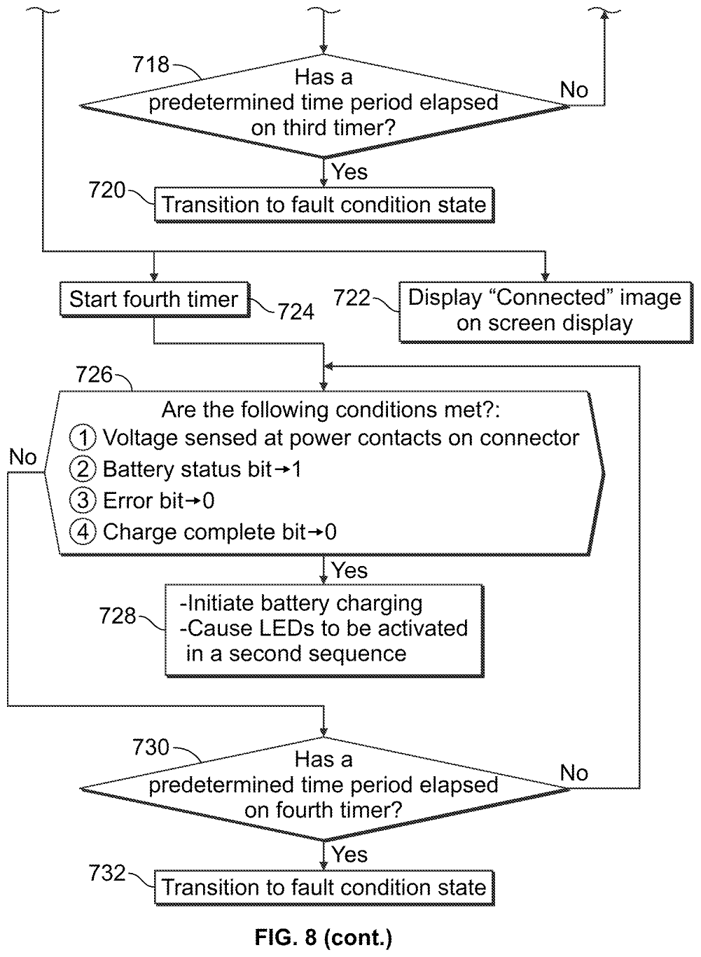

The exit conditions for the battery charger controller 306 to change states 602. 604. 606 and 608, will be noted during the following discussion of a flowchart 700 illustrated in FIG. 8. The flowchart 700 in FIG. 8 is an example process for operation of the battery charger controller 306 before, during and after a battery charging operation. The process in FIG. 8 can, for example, be implemented with executable code that is executed by the one or more processors of the battery charger controller 306.

As noted above, when in the idle state 602, the battery charger controller 306 continuously polls for message traffic, e.g., CAN messages, on the vehicle network system 210, e.g., the CAN bus, see step 701. As also noted above, once the battery charger connector 310 has been coupled to the battery connector 142, the battery charger controller 306 may see messages broadcast from the vehicle 100 (passing through the battery system 130) and/or the battery system 130 over the network system 210. Once messages are detected, see step 702, the battery charger controller 306 starts a second timer, see step 704. After the second timer has been initiated, the battery charger controller 306 waits to receive a message via the vehicle network system 210 with a node ID corresponding to the battery controller 134. Once a message is received and identified with a node ID corresponding to the battery controller 134, see step 706, the battery charger controller 306 transitions to the connecting state 604. After transitioning to the connecting state 604, the second timer is stopped and a third timer is initiated, see step 708. Also, once transition to the connecting state 604 has occurred, the battery charger controller 306 causes the image on the screen display 312 to change from the “charger ready” image 802, see FIG. 9A, to the “connecting” image 804, see FIG. 9B, see step 710. The battery charger controller 306 may also activate the one or more of the LEDs 820 to generate the first visual signal, see step 710. If a predetermined time period, e.g., between 5-10 seconds. elapses from when the second timer is started and no message with a node ID corresponding to the battery controller 134 is received and identified by the battery charger controller 306, see step 712, then the battery charger controller 306 transitions to a fault condition state, see step 714. When in the “fault condition” state, the battery charger controller 306 will cause a “charger error” image to be displayed on the screen display 312 and will not effect charging of the battery 132. Once the battery charger connector 310 has been disconnected from the battery connector 142, the battery charger controller 310 returns to the idle state 602.

After the third timer has been initiated, the battery charger controller 306 waits to receive a message via the vehicle network system 210 from the battery controller 134 containing the “charger detect” bit=1, see step 716. Once such a message is received, the battery charger controller 306 transitions from the “connecting” state 604 to the “connected” state 606. After entering the “connected” state 606, the battery charger controller 306 may change the “connecting” image 804 to the “connected” image 806, see FIG. 9C and step 722, and also generate the connected alarm tone. The battery charger controller 304 may also stop the third timer and start a fourth timer, see step 724, after entering the “connected” state 606.

If a predetermined time period, e.g., between 5-10 seconds, elapses from when the third timer is started and a message with the “charger detect” bit=1 is not received by the battery charger controller 306, see step 718, then the battery charger controller 306 enters the “fault condition” state, see step 720.

After starting the fourth timer, the battery charger controller 306 determines if the following conditions are met, see step 726:
1) Is a voltage detected by the battery charger controller 306 at the first and second power contacts 310E and 310F of the battery charger connector 310, wherein the first and second power contacts 310E and 310F are connected to the first and second power conductors on the battery connector 142 when the battery and battery charger connectors 142 and 310 are coupled to one another:
2) Is a battery status bit=1 (this bit is sent by the battery controller 134 to the battery charger controller 306 via a CAN message: when the battery status bit is equal to 1, this indicates that the battery is capable of accepting a charge);
3) Is an error bit=0) (this bit is sent by the battery controller 134 to the battery charger controller 306 via a CAN message: when this bit is equal to 0, this indicates that there is an absence of errors in the battery controller 132):
4) Is a charge complete bit=0) (when this bit equals 0, it indicates that the battery in not fully charged: this bit is sent to the battery charger controller 306 via a CAN message). When all four conditions have been met, the battery charger controller 306 changes from the “connecting” state 606 to the “charging” state 608. Once the state changes, the battery charger controller 306 initiates battery charging, i.e., charging current is provided by the charging circuity 304 to the battery 132 via the cable 308 and the connector 310, see step 728. The battery charger controller 306 may further activate one or more of the LEDs 820 on the front of the battery charger housing 302 to create a second visual signal. For example, four of the LEDs 820 may be activated in a circular alternating manner. e.g., while one LED is ON the other three LED are OFF, to generate the second visual signal. It is also contemplated that one or more of the LEDs 820 may be activated in any other manner so as to generate the second visual signal.

If a predetermined time period, e.g., 5-10 seconds, elapses from when the fourth timer was started and all four conditions set out in step 726 are not met, see step 730, then the battery charger controller 306 enters the “fault condition” state, see step 732.

When an operator wishes to charge the battery 132, the operator couples the battery charger connector 310 to the battery connector 142. Based on the battery charger controller 306 seeing messages on the network system 210, e.g., the CAN bus, and receiving a message with a node ID corresponding to the battery controller 134, the battery charger controller 306 changes the screen display 312 from displaying the “charger ready” image 802, see FIG. 9A, to the “connecting” image 804, see FIG. 9B. The “connecting” image 804 may be displayed on the screen display 312 very quickly from when the operator couples the battery charger connector 310 to the battery connector 142, e.g., from about 1 second to about 3 seconds from when coupling occurs. The “connecting” image provides the operator with very early feedback indicating that the battery charger connector 310 has been coupled to the battery connector 142 and sensed by the battery controller 134, but the battery charger controller 306 has not yet received confirmation of the connection from the battery controller 134. Soon thereafter, once the battery charger controller 306 receives the message with the “charger detect” bit=1 from the battery controller 134, the battery charger controller 306 may change the “connecting” image 804 to the “connected” image 806, see FIG. 9C, and also generate the connected alarm tone, thereby verifying that the battery charger controller 306 has received confirmation of the connection of the connectors 142 and 310 from the battery controller 134. This provides the operator with very early feedback that the battery charger connector 310 has been properly connected to the battery connector 142. The “connected” image 804 may be displayed on the screen display 312 within approximately 1 second to 3 seconds from when the operator couples the battery charger connector 310 with the battery connector 142. For example, early feedback may allow the operator to begin to walk away from the location where the operator connected the battery charger connector 310 with the battery connector 142 once the operator sees the “connecting” image and thereafter listen for the connected alarm tone as an assurance that the battery charger connector 310 has been properly connected to the battery connector 142. This is an improvement as much quicker feedback is provided to the operator as compared to the prior art where an operator would need to wait for a “charging” image to be displayed on the screen display 312, which may take up to 15 seconds after the operator has coupled the battery charger connector with the battery connector.

In a further embodiment, step 710, see FIG. 8, may be deleted/avoided such when transitioning to the “connected” state 606, the battery charger controller 306 may change the “charger ready” image 802 to the “connected” image 806. Hence, the “connecting” image 804 is never displayed.

Having thus described the above aspects of the disclosure in detail and by reference to embodiments thereof, it will be apparent that modifications and variations are possible without departing from the scope of the disclosure defined in the appended claims.

What is claimed is:

1. A battery charger for a battery system, the battery system adapted to provide power to a vehicle, the battery charger comprising:
a housing:
a charger connector adapted to be connected with a mating connector of the battery system:
memory storing executable instructions: and
a processor in communication with the memory, wherein the processor when executing the executable instructions:
determines that identification information from the battery system is received by the processor via the charger connector, the identification information is received by the charger connector via a vehicle network: and
after the identification information from the battery system is received, generates first information indicating that the battery charger is connecting with the battery system.

2. The battery charger of claim 1, further comprising a screen display, wherein the first information is displayed on the screen display indicating that the battery charger is connecting with the battery system.

3. The battery charger of claim 2, wherein the first information displayed on the screen display comprises graphic and/or alphanumeric information indicating that the battery charger is connecting with the battery system.

4. The battery charger of claim 2, further comprising one or more signal emitting devices, wherein the processor when executing the executable instructions:
after the identification information from the battery system is received, generates further first information by activating the one or more signal emitting devices to generate a first visual signal at the one or more signal emitting devices.

5. The battery charger of claim 1, wherein the identification information from the battery system comprises a node identification.

6. The battery charger of claim 1, wherein the processor when executing the executable instructions:
determines that a charger detect signal from the battery system is received by the processor via the charger connector.

7. The battery charger of claim 6, wherein the processor when executing the executable instructions:
after the charger detect signal is received, generates second information indicating that the battery charger is connected with the battery system.

8. The battery charger of claim 7, further comprising a screen display, wherein the second information is displayed on the screen display indicating that the battery charger is connected with the battery system.

9. The battery charger of claim 8, wherein the second information displayed on the screen display comprises graphic and/or alphanumeric information indicating that the battery charger is connected with the battery system.

10. The battery charger of claim 9, further comprising a speaker, wherein the processor when executing the executable instructions:
after the charger detect signal is received, generates further second information by causing the speaker to emit a first sound indicative that the battery charger is connected with the battery system.

11. The battery charger of claim 7, further comprising a charging system for recharging the battery system, wherein the second information is generated prior to the charging system starting a recharging operation for the battery system.

12. A method for providing information regarding connecting a battery charger with a battery system, the battery system adapted to provide power to a vehicle, the method comprising:
determining, by a processor of the battery charger, that identification information from the battery system is received, the identification information is received by the processor via a vehicle network; and
after the identification information from the battery system is received, generating, by the processor, first information indicating that the battery charger is connecting with the battery system.

13. The method of claim 12, further comprising:
causing, by the processor, the first information to be displayed on a screen display indicating that the battery charger is connecting with the battery system.

14. The method of claim 13, wherein the first information displayed on the screen display comprises graphic and/or alphanumeric information indicating that the battery charger is connecting with the battery system.

15. The method of claim 14, further comprising:
after the identification information from the battery system is received, generating, by the processor, further first information by activating one or more signal emitting devices to generate a first visual signal at the one or more signal emitting devices.

16. The method of claim 12, wherein the identification information from the battery system comprises a node identification.

17. The method of claim 12, further comprising:
determining, by the processor, that a charger detect signal from the battery system is received by the processor via the charger connector.

18. The method of claim 17, further comprising:
after the charger detect signal is received, generating, by the processor, second information indicating that the battery charger is connected with the battery system.

19. The method of claim 18, further comprising:
causing, by the processor, the second information to be displayed on a screen display indicating that the battery charger is connected with the battery system.

20. The method of claim 19, wherein the second information displayed on the screen display comprises graphic and/or alphanumeric information indicating that the battery charger is connected with the battery system.

21. The method of claim 17, further comprising:
after the charger detect signal is received, causing, by the processor, a speaker to emit a first sound indicative that the battery charger is connected with the battery system.

22. The method of claim 18, wherein the second information is generated prior to a charging system starting a recharging operation for the battery system.

23. The method of claim 12, wherein the first information is generated prior to a charging system starting a recharging operation for the battery system.

24. A battery charger for a battery system, the battery system adapted to provide power to a vehicle, the battery charger comprising:
a housing:
a charger connector adapted to be connected with a mating connector of the battery system:
memory storing executable instructions; and
a processor in communication with the memory, wherein the processor when executing the executable instructions:
determines that a charger detect signal from the battery system is received by the processor via the charger connector; and
after the charger detect signal is detected, generates information indicating that the battery charger is connected with the battery system.

25. The battery charger of claim 24, further comprising a screen display, wherein the information is displayed on the screen display indicating that the battery charger is connected with battery system.
